(19) United States
(12) Patent Application Publication
(10) Pub. No.: US 2004/0173459 A1
(43) Pub. Date: Sep. 9, 2004

(54) Method for improving the performance of electrokinetic micropumps

(76) Inventor: Brian J. Kirby, San Francisco, CA (US)

Correspondence Address: Timothy P. Evans, MS 9031, Sandia National Laboratories, 7011 East Avenue, Livermore, CA, 94550, US

(21) Appl. No.: 10/799,188

(22) Filed: Mar. 12, 2004

Related U.S. Application Data
(62) Division of application No. 10/253,144, filed on Sep. 24, 2002.

(51) Int. Cl. G01N 27/453

(52) U.S. Cl. 204/454; 204/601

(57) ABSTRACT

A method for improving the pumping performance of an electrokinetic pump. The addition of zwitterions to the pump fluid or electrolyte of an electrokinetic pump (EKP) has been found to improve the pumping performance by increasing the maximum pressure and flow rate generated and increasing the efficiency for a given applied voltage. Zwitterions comprise a class of molecules that contain separated positive and negative charge centers within the molecule, are substantially electrically neutral, and generally exhibit a large inherent dipole moment (≈20−25 D) as a consequence of charge separation within the structure of the molecule. The addition of the zwitterion trimethyl ammonium propane sulfonate to an EKP electrolyte has resulted in a 3-fold increase in pump efficiency and a 2.5-fold increase in generated pressure for a given applied voltage.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### CROSS-REFERENCE TO RELATED APPLICATIONS

Not applicable.

### FIELD OF THE INVENTION

This invention is directed to a method for increasing the performance of electrokinetic pumps by the use of additives, in the form of zwitterions, to the pumping fluid.

### BACKGROUND OF THE INVENTION

Micro Total-Analysis Systems (μTAS) have received a great deal of recent attention owing to their ability to improve the performance of chemical analysis systems by reducing footprint, reagent volumes, and electrical power needs. As a crucial component of μTAS research, micropumps have been investigated as a means to move fluids and actuate microscale mechanical components. Electrokinetic micropumps (EK pumps) have been shown to generate pressures above 8000 psi or flow rates above 1 μl/min, making them attractive for miniaturization of HPLC systems (cf. U.S. Pat. No. 6,277,257 “Electrokinetic High Pressure Hydraulic System”), cooling of microelectronics, and actuation of microscale mechanical components. Thus, EK pumps are ideally suited for micro total-analysis systems since they can straightforwardly meter the very low flow rates (nl/min or μl/min) that are typically used, and can generate high pressure (thousands of psi) required for chromatographic separations.

An EK pump uses electroosmosis in charged porous media to generate a pumping function and is realized experimentally by applying voltage across a porous bed possessing a charged-solid-liquid interface, as shown in FIG. 1. Electroosmosis due to the applied electrical field causes fluid flow and generates a pressure whose magnitude depends on the Darcy permeability of the fluidic channels downstream of the pump. Pump performance is dictated by substrate material and geometry as well as fluid properties. In order to facilitate miniaturization of μTAS and microfluidically driven systems generally it is desirable to incorporate improvements that lead to reduction in voltage and power requirements and improved fluid flow rates.

### SUMMARY OF THE INVENTION

Accordingly, the present invention is directed generally to improving the performance of electrokinetic (EK) pumps through the use of zwitterion additives in the pumped fluid.

The permittivity or dielectric constant (ε) of a pumping fluid is a fundamental performance parameter of an EK pump system. For maximum pressure performance ε should be maximized. Since ε is a strong function of solute concentration, increases in solute concentration should have a beneficial effect on ε and pressure performance of an EK pump. Charged solutes, such as NaCl cause a decrease in permittivity of water and lead to undesirable increase in conductivity and joule heating. However, chemical compounds such zwitterions when dissolved in the pumped fluid influence EK pump performance by increasing permittivity ε without increasing fluid conductivity. In fact, net neutral zwitterions typically reduce conductivity to additional benefit. The use of these chemical compounds as additives to EK pump fluids has been shown to result in a 3-fold increase in pump efficiency and a 2.5-fold increase in generated pressure for a given applied voltage.

### BRIEF DESCRIPTION OF THE DRAWINGS

FIG. 1 is a schematic illustration of a generic electrokinetic pump.

FIG. 2 shows the pressure/volt plotted as a function of the TMAPS additive concentration.

FIG. 3 shows EK pump efficiency as a function of solute concentration.

### DETAILED DESCRIPTION OF THE INVENTION

In accordance with the present invention, it has been discovered that the use of a class of additives, generally comprising zwitterions, which when added to the pump fluid, or electrolyte, improve the pumping performance of electrokinetic pumps by increasing the maximum pressure and flow rate generated as well as the maximum efficiency for a given applied voltage.

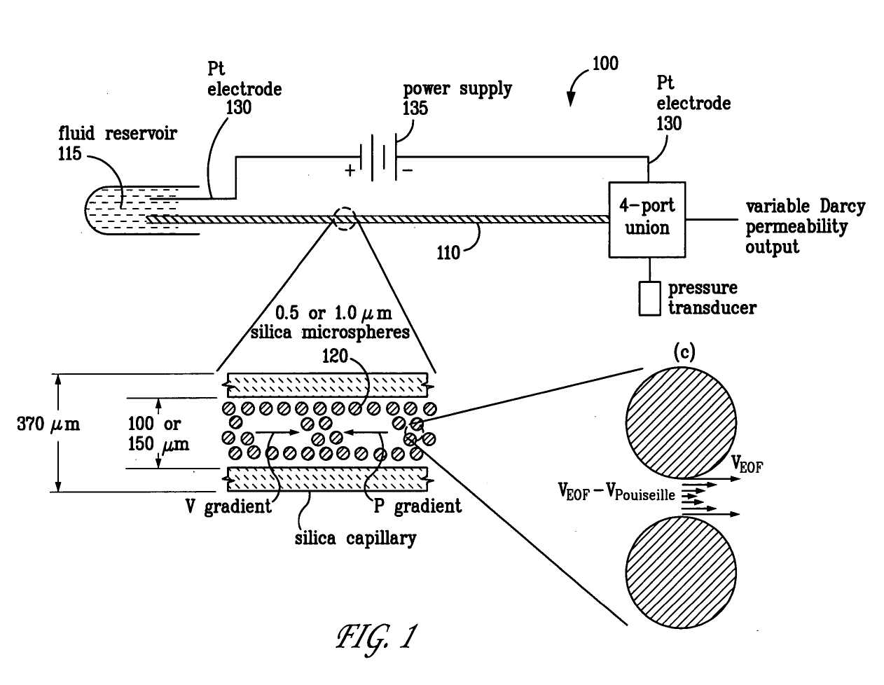

In order to understand the present invention better, the following introductory discussion is provided. An electrokinetic pump comprises an apparatus for converting electric potential to hydraulic force. Referring now to FIG. 1, an electrokinetic pump or EKP 100 typically consists of at least one duct or channel 110, that can be a capillary channel or microchannel, that forms a fluid passageway having an inlet and an outlet. The capillary duct or channel contains an electrolyte 115 and has a porous stationary phase or substrate comprising a nonporous dielectric medium 120 disposed therein between one or more pairs of spaced electrodes 130. Porous dielectric medium 120 can include small particles, high surface area structures fabricated within the microchannel, or microporous materials such as monolithic polymer networks (cf. U.S. patent application Ser. No. 09/796,762 “Castable Three-dimensional Stationary Phase for Electric Field-driven Applications”). An electric potential 135 is applied between electrodes 130 in contact with electrolyte, or pump fluid, 115, that can be an aqueous or an organic liquid or mixtures thereof, to cause the electrolyte to move in the microchannel by electroosmotic flow and generate a pressure whose magnitude depends on the Darcy permeability of the fluidic channels downstream of the pump. Pump performance in terms of pressure generated per volt of applied electric potential is determined by composition of the porous dielectric material or substrate material and geometry as well as the properties of the electrolyte. Throughout the written description of the invention the terms “electrolyte” and “pump fluid” will be used interchangeably and synonymously.

At the interface between a charged solid and an electrolyte solution and electrochemical double layer is formed and the mobile (diffuse) component of the double layer moves in response to the force generated by an externally applied electric field giving rise to electroosmotic flow. Assuming a cylindrical capillary geometry with radius a and phenomenological zeta potential ζ as well as a liquid with viscosity μ and permittivity ε, Poisson's charge density equation and Stokes' flow equations can be combined to give the electroosmotic flow profile as

$$u ( r ) = \frac{{P}_{x}}{4 μ} ( {a}^{2} - {r}^{2} ) - \frac{ϵζ E}{μ} \qquad ( 1 )$$

where P_{X} is the pressure gradient along the axis, r is the radial position, and E is the uniform electrical field. Equation 1 can be used to derive a number of performance relations for EK pumps that consist of linear capillaries and operate in the thin-double-layer limit. Practical EK pumps consist not of linear capillaries but rather a porous bed; Equation 1 can thus quantitatively treat porous media only if additional parameters (e.g., formation factors, porosity, tortuosity) are used to adapt the microchannel geometry to that of the porous bed. These additional parameters add multiplicative factors to Equation 1 and the derived results to follow. However, we are concerned primarily with the relative performance increase observed upon addition of specific fluid additives, thus the treatment for an idealized linear capillary system will be retained; it is simple and sufficient for this purpose.

From Equation 1 we can derive that the maximum pressure per volt generated in such a capillary (i.e., the pressure performance at zero net flow rate) is

$$\frac{Δ {P}_{max}}{V} = \frac{8 ϵζ}{{a}^{2}} \qquad ( 2 )$$

where V is the applied voltage. As a practical example, we can use Equation 2 to estimate that for a packed bed of 0.5 μm silica beads (effective pore radius a≈100 nm) and an electrolyte fluid consisting of a 10 mM aqueous Tris [Tris-(hydroxymethyl)aminomethane hydrochloride] buffer (ζ˜60 mV), the maximum pressure achieved will be 4.9 psi/volt.

Expanding the microchannel model to consider an array of identical microchannels of length 1 and total open cross-sectional area A, the maximum flow rate generated per applied volt can be derived as

$$\frac{{Q}_{max}}{V} = \frac{ϵζ A}{μ l} \qquad ( 3 )$$

Returning to the packed silica bead example and assuming the beads are packed into a 150 μm diameter cylindrical porous bed with a porosity of 0.33 and length of 5 cm, Equation (3) gives Qₘₐₓ/V=0.3 μl/min/kV.

Since this flow is in the Stokes regime, the system is linear and a straightforward relationship for the flow rate or generated pressure can be derived from Equations 2 and 3:

$$Q = {Q}_{max} ( \frac{Δ {P}_{max} - Δ P}{Δ {P}_{max}} ) \qquad ( 4 )$$

Finally, we can define the efficiency as

$$η = \frac{Q Δ P}{V I} \qquad ( 5 )$$

where VI is the applied electrical power and QΔP is the generated mechanical power. Thus, for a given value of applied electric power, the higher the efficiency the greater the generated mechanical power. Here we have tacitly ignored the convective contribution to the charge transport, an assumption that is typically valid only at high ionic strength. Differentiating Equation (5) and inserting Equation (4) leads to the conclusion that maximum efficiency is achieved at P=0.5 Pₘₐₓ.

From Equations 2-5, design requirements for the substrate material, substrate porosity, solvent fluid, and dissolved species in the thin double layer limit are clear. The substrate material affects the zeta potential γ, and maximizing γ will maximize pressure, flow rate, and performance. Silica surfaces have high wall γ potentials at neutral pH and above, and are a common material choice. Choice of pore size directly affects pressure performance but does not affect flow rate. Solvents should be chosen to maximize permittivity and minimize viscosity. Water has typically been an attractive fluid for high-pressure applications, due to its high permittivity (ε˜81, μ=1 mPa s at room temperature), while the addition of acetonitrile to aqueous pump fluids increases pumping rates, since its permittivity and viscosity (ε˜37, μ=0.37 mPa s) lead to a slightly better ε/μ ratio.

A minimum buffer concentration is often necessary for chemical analysis or synthesis. Here we assume that a nominal buffer concentration is required, and that that concentration leads to thin double layers. In this limit, addition of further charged species increases conductivity and power dissipation in the fluid, reducing efficiency and increasing unwanted thermal effects. Added counterions also reduce the zeta potential. Hence, in the thin double layer limit, efficiency is inversely proportional to concentration of charged species.

While uncharged solute additives do not significantly affect conductivity, double layer thickness, wall zeta potential, or pH, they can have a large impact on the permittivity and viscosity of the solution. In general, the permittivity of a dielectric electrolyte solution can be approximated using a linear dielectric increment dε/dC:

$$ϵ ( C ) = ϵ ( 0 ) + \frac{ⅆ ϵ}{ⅆ C} C \qquad ( 6 )$$

where C is the concentration of solute and the linear dielectric increment is a property of the specific solute-solvent system. Normalizing these values, we can write

ε*=1+γ_{ε}C (7)

where ε*=ε/ε(0) and γ_{ε}_{_{—}}=dε/dC/ε(0). Equation 6 is rigorously valid only for infinitesimal concentrations but is typically accurate for practical concentrations, and will be shown below to be applicable up concentrations as high as 2.5 M for some additives.

Upon addition of an uncharged additive, the electroosmotic flow velocity scales with the permittivity change, leading to a change in pressure performance:

$$\frac{{P}_{max} \text{/} V}{{( {P}_{max} \text{/} V )}_{0}} = 1 + {γ}_{ϵ} C \qquad ( 9 )$$

Here and in the following equations, the subscript 0 denotes the value at zero concentration. The change in EOF velocity similarly affects flow, but is offset by changes in the fluid viscosity:

$$\frac{{Q}_{max} / V}{{( {Q}_{max} / V )}_{0}} = \frac{1 + {γ}_{ϵ} C}{{μ}^{*}} \qquad ( 10 )$$

where μ*=μ/μ(0) is the normalized viscosity whose functional form is left unspecified. Pressure and flow effects combine to give the efficiency:

$$\frac{η}{{η}_{0}} = \frac{{( 1 + {γ}_{ϵ} C )}^{2}}{{μ}^{*}} \qquad ( 11 )$$

From Equations 9-11, it is clear that chemical compounds with large γ_{ε} e.g., large dipole moment, can greatly enhance EK pump performance as additives to the electrolyte. From the discussion above, it is also clear that it is desirable that the additives be uncharged. Such a class of chemical additives is characterized and represented by the genus zwitterions.

Zwitterions comprise a class of molecules that contain separated positive and negative charge centers within the molecule, are substantially electrically neutral, and generally exhibit a large inherent dipole moment (≈20−25 D) as a consequence of charge separation within the structure of the molecule. Positive charges can arise from one or more groups within the molecule including primary amine, secondary amine, tertiary amine, or quaternary amine. Negative charges can arise from one or more of the groups including sulfonate, phosphate, carbonate, or carboxylate.

The dielectric increment (dε/dC) of zwitterions stems primarily from the additive effect of their dipole moments to the inherent dipole moment of the solvent. Many families of zwitterions (e.g., trialkyl ammonium alkane sulfonates, alkyl imidazole alkane sulfonates, alkyl pyridine alkane sulfonates) have large positive dielectric increments (>40/M) in water, and are readily soluble in water such that solution concentrations above 1 M can be prepared. When added to aqueous pump solutions, zwitterions lead to large permittivity increases and thus provide for improved pump efficiency, pressure, and flow.

In the example below, the improvement in EK pump performance, namely increased maximum pressure generated per volt of applied electric potential and improved efficiency, realized by adding the zwitterion trimethyl ammonium propane sulfonate (TMAPS) to the EK pump fluid is demonstrated. TMAPS was chosen both for its high dielectric increment as well as commercial availability. TMAPS is known to have a dε/dC of +52/M, is uncharged at neutral pH, and is soluble to 3.5 M.

While one aspect of the invention will be illustrated by the example below this example only serves to illustrate the invention and is not intended to be limiting. Modifications and variations may become apparent to those skilled in the art, however these modifications and variations come within the scope of the appended claims. Only the scope and content of the claims limit the invention.

### EXAMPLE

Electrokinetic pumps similar to that shown in FIG. 1 were prepared. Porous stationary phase 120 was 0.5 or 1.0 μm nonporous silica microspheres. The inlet end of the pump was immersed in the running solution and voltage was applied by a high-voltage power supply. The high-pressure end of the pump was electrically grounded and connected through the pump fluid to both a pressure transducer and an outlet with controlled Darcy permeability (infinite for Pₘₐₓ/V measurements, zero for Qₘₐₓ/V measurements, approximately the permeability of the pump for η measurements). Pressure was given by the transducer output, and flow rate was calculated from microscopic observation of the motion of the liquid-air meniscus in a 149 μm ID capillary. Voltage and current were monitored using an electrometer, and a computer was used to acquire data.

Solution viscosities, necessary to predict flow rate performance, were inferred by using a syringe pump to induce a controlled 12.5 μl/min flow rate through a 1 m length of 150 μm ID capillary and observing the upstream pressure.

The effect of TMAPS on pump performance was evaluated by measuring flow, pressure, and efficiency of two EK pumps with solutions with varying TMAPS concentrations. One pump, denoted as pump A, was a 150 μm diameter capillary packed with 1 μm silica beads; the second pump is denoted as pump B and consisted of a 100 μm diameter capillary packed with 0.5 μm silica beads.

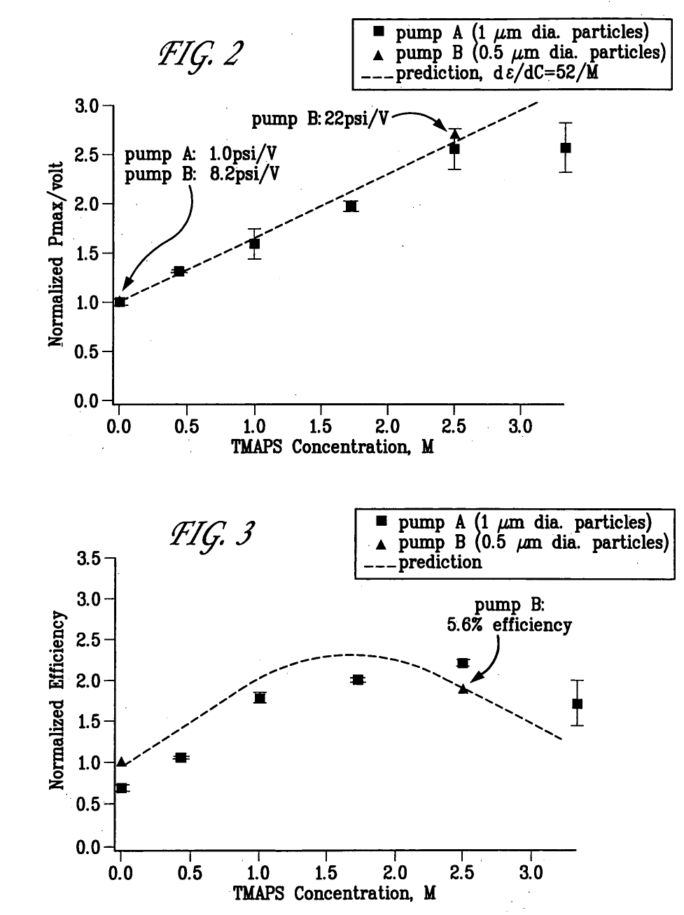

The maximum-pressure performance of the pump was measured by sealing the pump outlet to produce zero net mass flux through the pump. The effect of TMAPS was observed by measuring Pₘₐₓ/V for various TMAPS concentrations in 10 mM pH 8 Tris buffers. At each concentration, equilibrium pressure was recorded as a function of several applied voltages, and the observed pressure vs. voltage curve was fit to a linear relationship, whose slope gives the pressure/volt parameter from Equation 2. FIG. 2 shows the pressure/volt response normalized by the value observed without TMAPS, plotted as a function of the TMAPS additive concentration. Error bars indicate the standard deviation of the linear fit. The TMAPS additive caused up to a 2.5-fold increase in the observed Pₘₐₓ/V over the Tris buffer alone, leading to Pₘₐₓ/V results as high as 22 psi/V. The increase was linear up to 2.5 M TMAPS, and is consistent (RMS error 8%) with a prediction using a linear model for dielectric constant (Equation 9). A least squares fit of the 0-2.5 M region gives an inferred dielectric increment of 47.6/M, which is in agreement with a reported value of 52/M for TMAPS (Lucy, C. A.; Woodland, M. A., Stockholm, Sweden 2002; The Swedish Chemical Society Analytical Division.) and is consistent with the value of 42.2/M reported for a similar compound, triethylammonium propane sulfonate. (Galin, M.; Chapoton, A.; Galin, J. C. Journal of the Chemical Society, Perkin Transactions 2 1993, 3, 545-553.)

From FIG. 2, we can also observe that while variation in fabrication can lead to changes in the absolute performance of individual pumps, these variations do not affect the relative impact of solute additives on performance.

Efficiency was calculated from pressure, flow, voltage, and current observations and the results are displayed in FIG. 3. Pump A was evaluated at P=0.47 Pₘₐₓ (η=0.996 ηₘₐₓ), and pump B was evaluated at P=0.65 Pₘₐₓ (η=0.91?ηₘₐₓ). The prediction of Equation 11 is shown for comparison. The addition of TMAPS increased the efficiency of the pump in the 0-2.5M TMAPS range. Equation 11 predicts a maximum efficiency at 1.6 M TMAPS, at which point the efficiency has increased by 2.2. The maximum increase in efficiency was seen at 2.5 M TMAPS, where the pump was 3.2 times as efficient as compared to Tris alone as the fluid. The maximum observed thermodynamic efficiency was obtained with pump B at 2.5 M TMAPS, an efficiency of 5.6%.

As shown in the example above, the permittivity increase caused by zwitterion additives will significantly improve pump and actuator performance. The increase will allow the μTAS designer greater freedom in device construction. For a given pressure or flow requirement, improved pump performance implies that smaller voltages may be used, reducing substrate voltage holdoff requirements, electrolysis and bubble generation, and (in portable, miniaturized systems) high-voltage board performance requirements. For a given voltage, increased pressure improves chromatographic performance while increased flow improves the temporal response of EK-pump-driven actuators.

I claim:

1. A method for improving the performance of an electrokinetic pump, comprising: adding a chemical compound to a pump fluid to increase the permittivity of the pump fluid, wherein the added chemical compound is substantially charge neutral and has a dipole moment.

2. The method of claim 1, wherein the chemical compound has a dipole moment of at least about 10 D.

3. The method of claim 1, wherein the chemical compound is a zwitterion.

4. The method of claim 3, wherein the zwitterion contains one or more positive charges from the group including primary amine, secondary amine, tertiary amine, or quaternary amine and one or more negative charges from the group including sulfonate, phosphate, carbonate, or carboxylate.

5. The method of claim 3, wherein the zwitterion is a trialkyl ammonium alkane sulfonate, an alkyl imidazole alkane sulfonate, or an alkyl pyridine alkane sulfonate.

6. The method of claim 5, wherein the zwitterion is trimethyl ammonium propane sulfonate.

7. The method of claim 1, wherein the pump fluid is an aqueous mixture.

8. An improved electrokinetic pump having
a) a microchannel with an inlet and an outlet and a porous dielectric material disposed therebetween,
b) an electrolyte in communication with the porous dielectric material, and
c) spaced electrodes in contact with said electrolyte, wherein the improvement comprises adding a chemical compound to said electrolyte to increase the permittivity of said electrolyte, wherein the added chemical compound is substantially charge neutral and has a dipole moment, and wherein the additive produces a positive dielectric increment in said electrolyte.

9. The electrokinetic pump of claim 8, wherein the chemical compound has a dipole moment of at least about 10 D.

10. The electrokinetic pump claim 8, wherein the chemical compound is a zwitterion.

11. The electrokinetic pump of claim 10, wherein the zwitterion contains one or more positive charges from the group including primary amine, secondary amine, tertiary amine, or quaternary amine and one or more negative charges from the group including sulfonate, phosphate, carbonate, or carboxylate.

12. The electrokinetic pump of claim 8, wherein the zwitterion is a trialkyl ammonium alkane sulfonate, an alkyl imidazole alkane sulfonate, or an alkyl pyridine alkane sulfonate.

13. The electrokinetic pump of claim 12, wherein the zwitterion is trimethyl ammonium propane sulfonate.

14. The electrokinetic pump of claim 8, wherein the electrolyte is an aqueous mixture.

15. An electrolyte for an electrokinetic pump, comprising: a fluid having a chemical compound dissolved therein, wherein the chemical compound is a zwitterion that is substantially charge neutral and has a dipole moment, and wherein the chemical compound produces a positive dielectric increment in said electrolyte.

16. The electrolyte of claim 15, wherein the chemical compound has a dipole moment of at least about 10 D.

17. The electrolyte of claim 15, wherein the zwitterion contains one or more positive charges from the group including primary amine, secondary amine, tertiary amine, or quaternary amine and one or more negative charges from the group including sulfonate, phosphate, carbonate, or carboxylate.

18. The electrolyte of claim 15, wherein the zwitterion is a trialkyl ammonium alkane sulfonate, an alkyl imidazole alkane sulfonate, or an alkyl pyridine alkane sulfonate.

19. The electrolyte of claim 18, wherein the zwitterion is trimethyl ammonium propane sulfonate.

20. The electrolyte of claim 15, wherein the fluid is an aqueous mixture.
